(19) United States
(12) Patent Application Publication
(10) Pub. No.: US 2017/0109697 A1
(43) Pub. Date: Apr. 20, 2017

(54) DOCUMENT VERIFICATION

(71) Applicant: DELL PRODUCTS L.P., Round Rock, TX (US)

(72) Inventors: Sachinrao Panemangalore, San Jose, CA (US); Vinay Sawal, Fremont, CA (US); Vivek Dharmadhikari, San Jose, CA (US); Kuntal Patel, Milpitas, CA (US); Gavin Richard Cato, Los Gatos, CA (US)

(73) Assignee: DELL PRODUCTS L.P., Round Rock, TX (US)

(21) Appl. No.: 14/885,015

(22) Filed: Oct. 16, 2015

(51) Int. Cl. G06Q 10/10; G06F 17/30

(52) U.S. Cl. CPC G06Q 10/10; G06F 17/30424; G06F 17/30598

(57) ABSTRACT

Aspects of the present disclosure related to systems and methods that help automate the detection of errors in technical documentation. Every functional product, be it a service, device, or combination thereof, has one or more supporting documents associated with that product. These supporting documents may include such documentation as: (1) Release Notes; (2) Configuration Guides; (3) command line interfaces (CLIs)/application program interfaces (APIs); (4) Data Sheets; (5) Installation Guides; (6) User Manuals; (7) Errata notices; and (8) other documentation. It is important that the information provided in such documents, particularly the commands, be correct. In embodiments, a document verification system may be used to automatically extracted commands from technical documentation. And, in embodiments, these extracted commands and a definition set of commands may be compared to automatically detect errors in the documentation, which detected errors may checked and corrected before being released to customers.

### TECHNICAL FIELD

The present disclosure relates to technical documentation and functional products. More particularly, the present disclosure related to systems and methods that help automate the detection of errors in technical documentation for functional products, such as devices and/or services.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Ever increasing demands for data and communications have resulted in vast arrays of ever expanding networks that comprise information handling systems. As these networks evolve and expand, new features and functionality are added at different times and for different reasons.

When new features are added to a product, new documentation needs to be generated that describes the new features and how to implement or execute those features. Because several changes may be made in a new version of a product or in a new product, the corresponding amount of documentation can also be quite voluminous.

Regardless of the amount of documentation, it is critical that the documentation accurately describe the product and its functionalities. If the documentation is incorrect (e.g., fails to include descriptions of new features, fails to exclude descriptions of features that are no longer supported, has omission, has typographical errors, or other errors), then customers are likely to become frustrated.

Frustrated customers are a serious concern to any business. Costs increase due to added technical support calls. Engineering talent is diverted from developing new products to troubleshooting. And, sales can be negatively impacted. Thus, any mismatches between a product's functionality and its corresponding documentation can have severe consequences to a company's profitability.

Given the complexity of today's information handling systems, not only is the documentation vast but it is also highly technical—making it quite difficult and laborious to check for errors. Furthermore, the engineers developing the products are often a different group than the ones that develop the documentation. While these groups try to work closely together, there is still opportunities for information to be missed and other errors to enter.

Accordingly, what is needed our systems and methods that help automate the process to check for errors in technical documentation.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 (“FIG. 1”) depicts a high-level methodology for document verification according to embodiments of the present patent document.

FIG. 2 depicts a high-level methodology for generating a command template database and a command context database from documentation according to embodiments of the present patent document.

FIG. 3 depicts a high-level methodology for normalizing a command definition data set according to embodiments of the present patent document.

FIG. 4 depicts an example of a method for building a command template database according to embodiments of the present patent document.

FIG. 5 depicts an example method for building a command context database according to embodiments of the present patent document.

FIG. 6 depicts an example methodology for normalizing a command definition data set according to embodiments of the present patent document.

FIG. 7 depicts an example methodology for performing command template query according to embodiments of the present patent document.

FIG. 8 presents an example methodology for performing error classification for one or more errors detected during command template querying according to embodiments of the present patent document.

FIG. 9 depicts an example methodology for performing command context query according to embodiments of the present patent document.

FIG. 10 presents an example methodology for providing errors for one or more errors detected during command context querying according to embodiments of the present patent document.

FIG. 11 presents an example document verification system according to embodiments of the present patent document.

FIG. 12 depicts a simplified block diagram of an information handling system according to embodiments of the present invention.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system/device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. Furthermore, the use of memory, database, information base, data store, tables, hardware, and the like may be used herein to refer to system component or components into which information may be entered or otherwise recorded.

The terms “packet,” “datagram,” “segment,” or “frame” shall be understood to mean a group of bits that can be transported across a network. These terms shall not be interpreted as limiting embodiments of the present invention to particular layers (e.g., Layer 2 networks, Layer 3 networks, etc.); and, these terms along with similar terms such as “data,” “data traffic,” “information,” “cell,” etc. may be replaced by other terminologies referring to a group of bits, and may be used interchangeably. The terms “include,” “including,” “comprise,” and “comprising” shall be understood to be open terms and any lists the follow are examples and not meant to be limited to the listed items. Any headings used herein are for organizational purposes only and shall not be used to limit the scope of the description or the claims.

Furthermore, it shall be noted that: (1) certain steps may optionally be performed; (2) steps may not be limited to the specific order set forth herein; (3) certain steps may be performed in different orders; and (4) certain steps may be done concurrently.

### A. GENERAL OVERVIEW

Aspects of the current patent document include systems and methods to extract data using natural language expressions in technical documents related to a product and to verify that data against formal structured data associated with source code for that product.

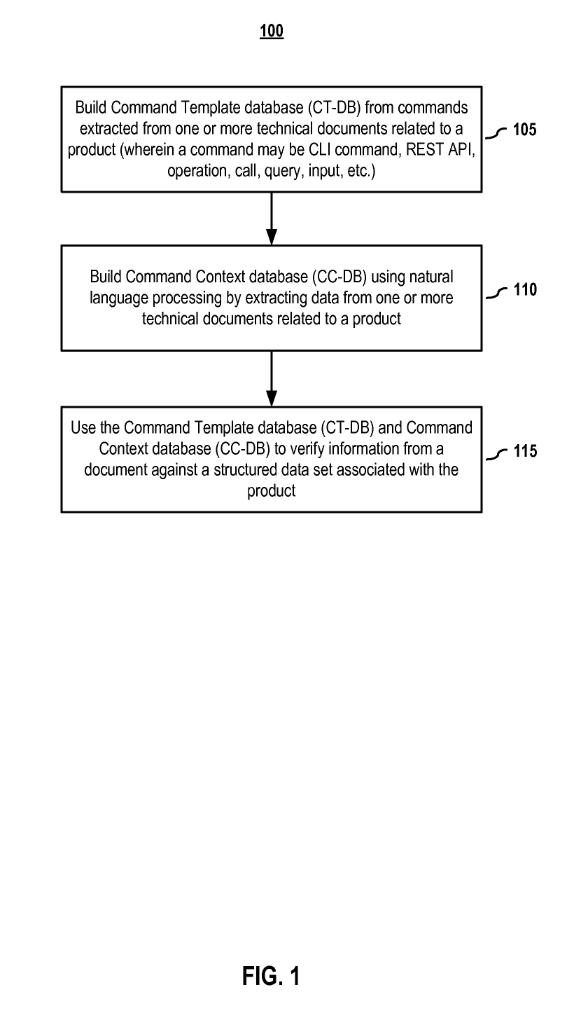

FIG. 1 depicts a high-level methodology for document verification according to embodiments of the present patent document. In embodiments, a command template database (CT-DB) is built (105) from commands extracted from one or more technical documents related to a product, which may be a device, service, or combination thereof. The term “command” shall be understood to cover a broad array of elements, such as a command-line-interface (CLI) command, an application programming interface (API), a Representational State Transfer (REST) API, an operation, a call, a query, an input, a request, a script, etc. Also, in embodiments, a command context database (CC-DB) is built (110) using natural language processing by extracting data from one or more technical documents related to a product. Then, in embodiments, the command template database (CT-DB), the command context database (CC-DB), or both are used (115) to verify information from documentation against a structured data set associated with the product.

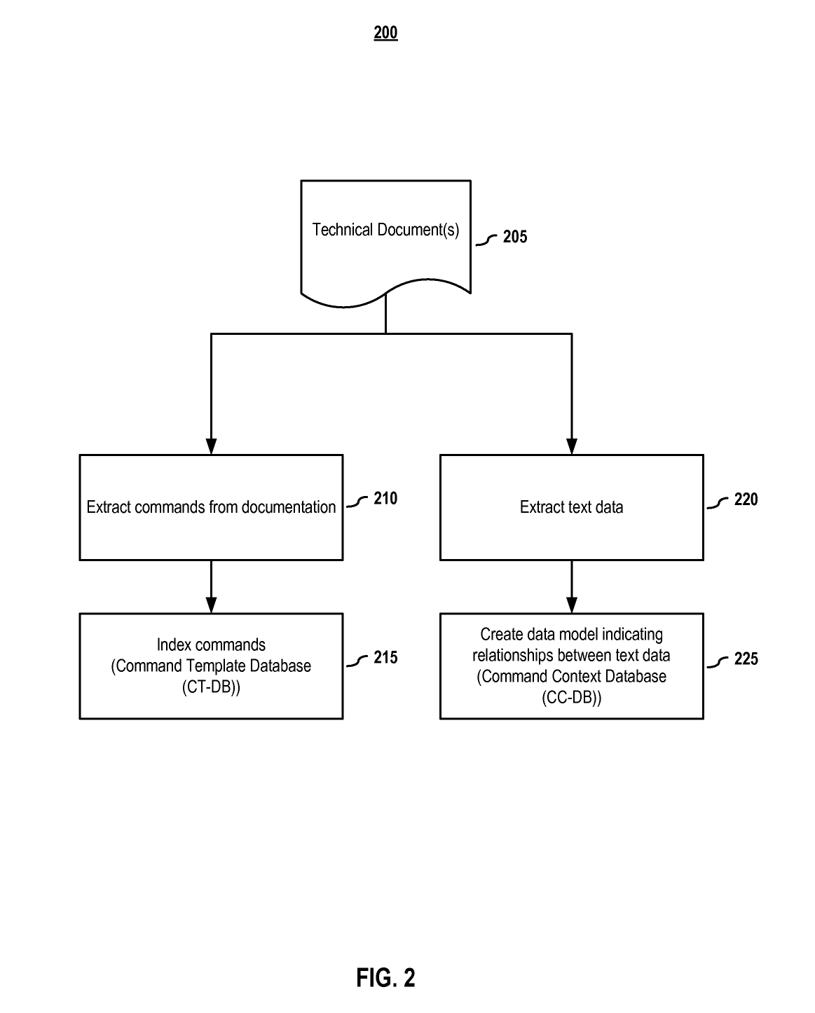

FIG. 2 depicts a high-level methodology for generating a command template database (CT-DB) and a command context database (CC-DB) from documentation according to embodiments of the present patent document. As shown in FIG. 2, one or more technical documents 205 are used to generate the CT-DB and the CC-DB. As will be explained in more detailed below, in embodiments, the CT-DB is generated from the technical document(s) by extracting (210) commands and indexing (215) them. And, as will be explained in more detailed below, in embodiments, the CC-DB is generated from the technical document(s) by extracting (220) text data and creating (225) a data model that represents relationships of parts of the text data.

In embodiments, the command template database (CT-DB), command context database (CC-DB), or both may be used to verify information from a document against a command definition data set associated with the product. For example, a command definition data set, such as a YANG (“Yet Another Next Generation”) data model, may be included with the source code of a product release, whether a new product release or an update release. A YANG model explicitly determines or defines the structure, semantics, and syntax of data, which can be configuration and state data. It should be noted that while references are made in this patent document to YANG models, other data models, schema, and the like (which may be referred to herein generally as a “structured data set,” a “definition data set,” or the like) may also be used.

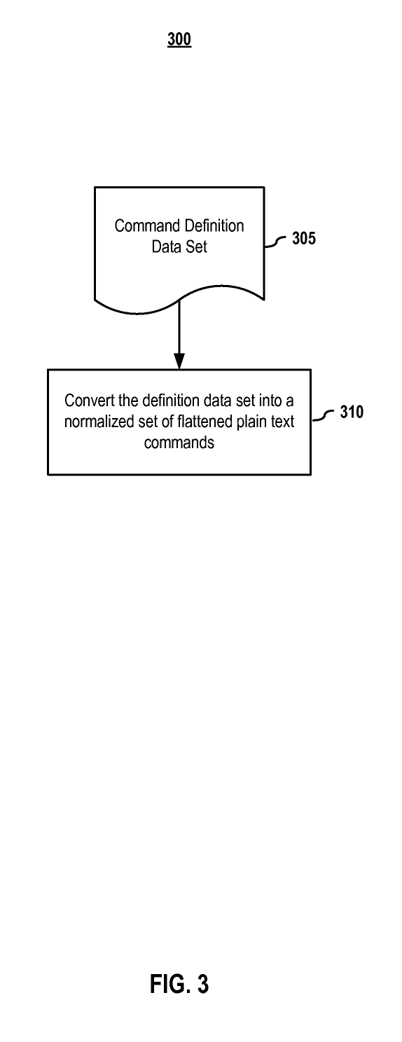

FIG. 3 depicts a high-level methodology for normalizing a command definition data set according to embodiments of the present patent document. As shown in FIG. 3, in embodiments, one or more command definition data sets 305 are used to generate (310) a set of normalized, flattened plain text commands. It is this data, which sets forth commands for an associated product, which is compared against the data extracted from documentation. In embodiments, if errors (or differences) are found, they may be further analyzed to ascertain the nature of the error or whether it is, in fact, an error.

### B. DATABASE GENERATION

### 1. Generating a Command Template Database (CT-DB)

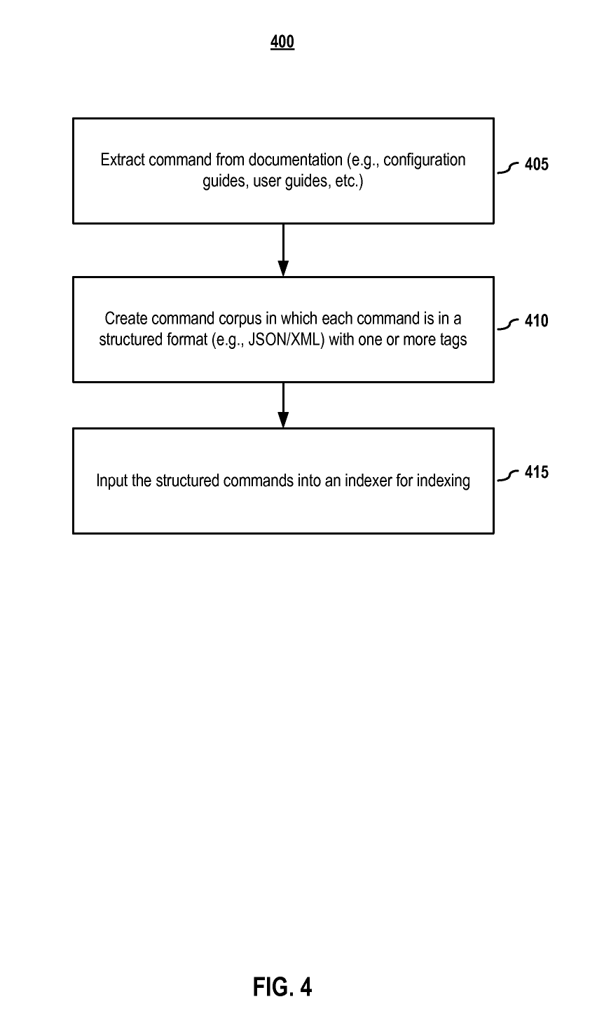

In embodiments, a command template database (DB) is consulted by the document verification system to lookup a command template for the particular product, which is a closest match to the command input selected from a structured data file associated with the particular device or platform. In embodiments, a term frequency-inverse document frequency (TF/IDF)-based ranking function is used to get the most relevant match for a command query input. In embodiments, the APACHE LUCENE index engine may be used to index commands (e.g., CLIs and REST APIs) for template lookup. FIG. 4 depicts an example of a method for building a command template database according to embodiments of the present patent document.

### (i) Command Extraction

As shown in embodiment depicted in FIG. 4, the process commences by extracting (405) commands from documentation. In embodiments, manual, semi-manual (using regular expressions, python, etc.), automatic methods, or combinations thereof may be used to extract commands from a document, such as configuration guides and other source materials. For example, font type and/or size and known precursor statement (e.g., <word>#, | for options, [ ] or ( ) for options, etc.) of the command-syntax may be used to extract command features. In embodiments, copying and pasting command definition tables from portable document format (PDF) files into command definition files tended to be more accurate than statistical models, although statistical models may also be used to automate the extraction. One skilled in the art shall recognize that there are many ways in which to extract or “mine” content, such as tables and other multi-column structures, from PDF and other documentation files in a deterministic way, and such approaches may be utilized herein.

### (ii) Command Indexing

Returning to FIG. 4, in embodiments, a command corpus is created (410) in a structured format (e.g., JavaScript Object Notation (JSON)/Extensible Markup Language (XML)) and it is labelled with one or more tags. In embodiments, the tags may include such things as key-value pairs (e.g., [interface_type:vlan], [name:vlan_name], etc.). The extracted commands may then, in embodiments, be inputted (415) into an indexer, such as LUCENE, for indexing to create one or more indexes of the target-specific command templates. It shall be noted that this is trivial from the LUCENE API point of view, in which the path to the JSON/XML documents are passed to the LUCENE Index API. The output is a set of indexes. These indexes may be used as part of a lookup when the document verification system wants to match the most relevant command object to the query command input. Embodiments of the lookup process are explained in more detail below.

### 2. Generating a Command Context Database (CC-DB)

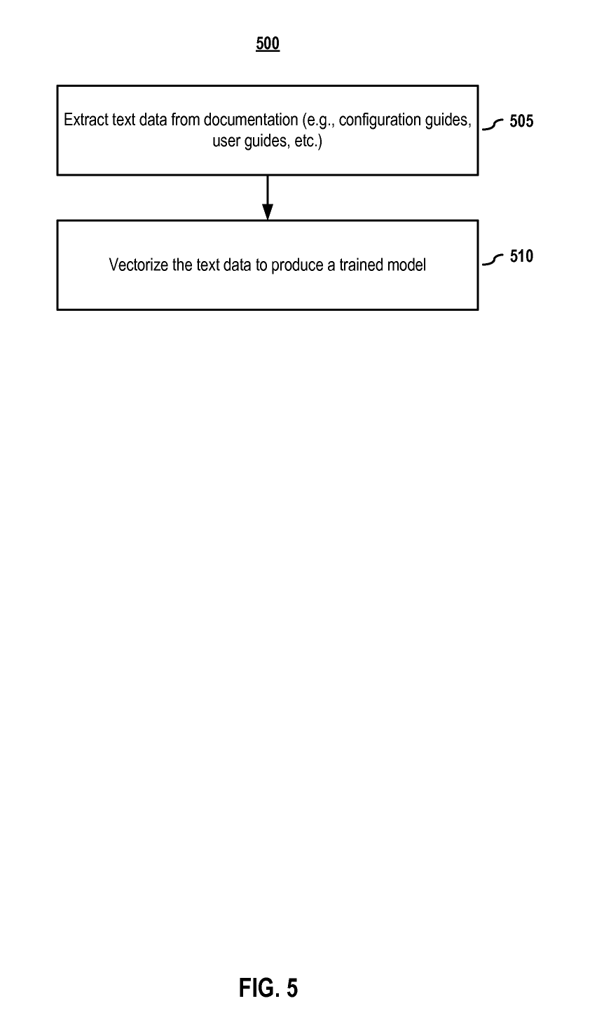

In embodiments, a command context DB is consulted by the document verification system to check if the semantic context of the command captured in the technical document matches that of the command definition file captured from the source code. The semantic context of a command in the technical document is usually the combined information entropy of the command, present in the description, examples, and references. FIG. 5 depicts an example method for building a command context database according to embodiments of the present patent document.

As shown in FIG. 5, in embodiments, text data from documentation (e.g., configuration guides, user guides, etc.) is extracted (505). Then, the text data is vectorized (510) to produce a trained model. In embodiments, the text data from the technical documents may be vectorized, using “Word2Vec” algorithm, which is an open source tool—although other vectorizing methods or algorithms may be used. Once the model is trained with the technical documents, this trained model (i.e., the CC-DB) may be queried to check context of a command, for example, by using “model.doesnt_matchQ” function in the gensim library, which is a free Python library—although other tools may be used or created to perform this function.

### C. COMMAND DEFINITION DATA SET NORMALIZED TEXT GENERATION

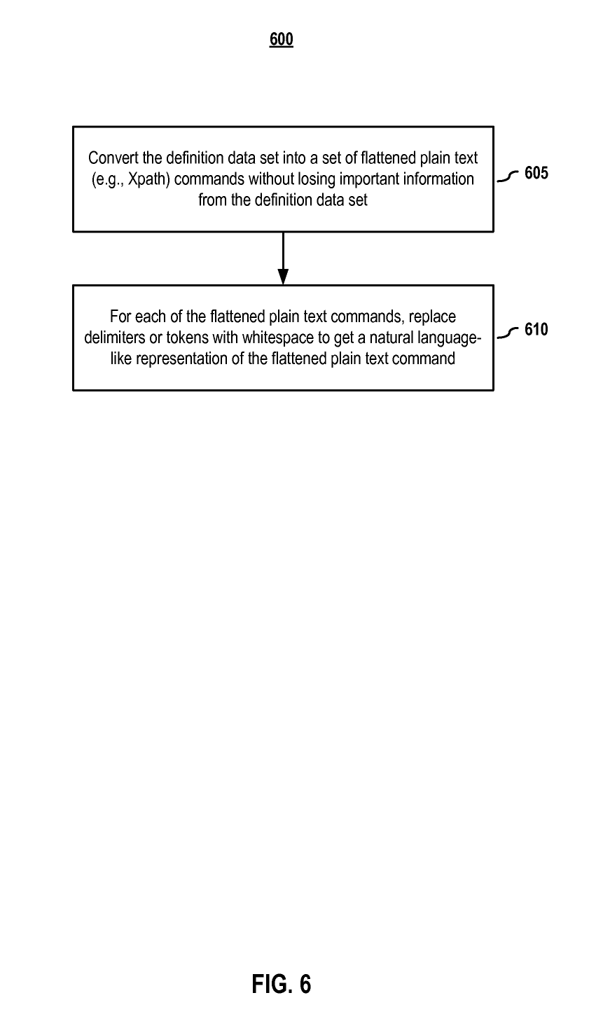

FIG. 6 depicts an example methodology for normalizing a command definition data set according to embodiments of the present patent document. As shown in FIG. 6, in embodiments, one or more command definition data sets associated with a product are converted (605) into a set of flattened plain text (e.g., Xpath) commands without losing important information from the definition data set. Then, in embodiments, for each of the flattened plain text commands, delimiters or tokens (e.g., “/”) are replaced (610) with whitespace to obtain a natural language-like representation of the flattened plain text command.

### D. QUERY/LOOKUP

Embodiments of the query/input lookup are presented below. In embodiments, the query may be done against the command template database, the command context database, or both. Also, it shall be noted that while embodiments involve one or more commands of the definition data set be compared against the data from the documentation (e.g., the command template database and the command context database), one skilled in the art shall recognize that data from the documentation may be compared against data generated using the definition data set, or may be compared both ways.

### 1. Querying the Command Template Database (CT-DB)

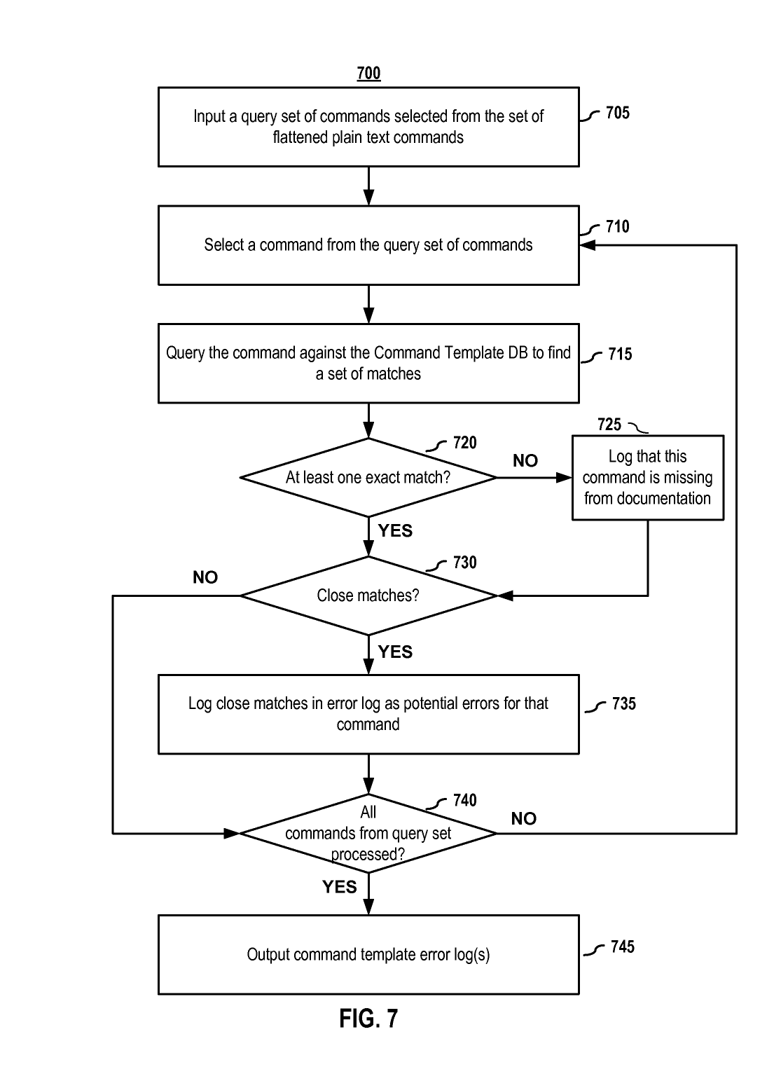

FIG. 7 depicts an example methodology for performing command template query according to embodiments of the present patent document. In embodiments, a query set of commands may be selected (705) from the set of flattened plain text commands. In embodiments, the query set may be all of the set of flattened plain text commands or may be a subset of them. Also, in embodiments, the selection may be by a user, may be selected automatically based upon one or more criteria, or may be a combination thereof.

In embodiment, one of the command from the query set of commands is selected (710) to be tested against the command template database. This selected command is queried (715) against the indexed command template database to find a set of matches, which may include commands that closely match. In embodiments, a term frequency-inverse document frequency (TF/IDF)-based ranking function is used to obtain the most relevant matches for a query command input.

The returned results may be examined to ascertain if one or more errors exist. In embodiments, the match results are checked to determine (720) whether or not there is at least one exact match. In embodiments, if there is not at least one exact match, then that query command, which exists in the code for the device, does not exist in the documentation, which is an error. Thus, in embodiments, it may be logged (725) that this command is missing from documentation.

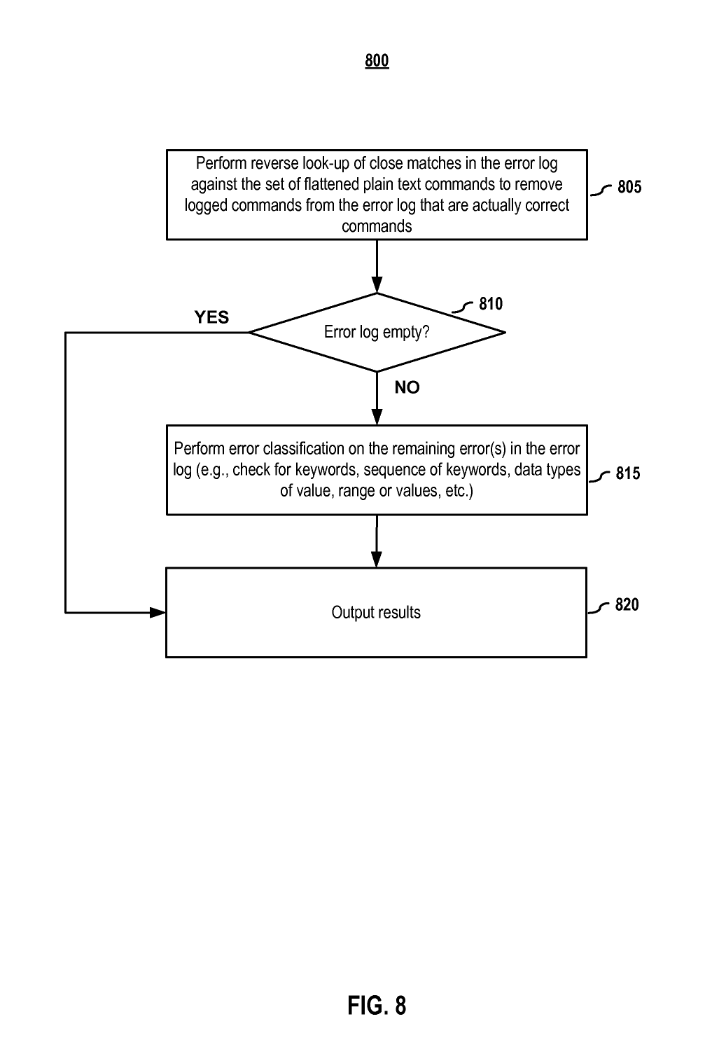

As shown in FIG. 7, in embodiments, the next step, whether or not there is at least one exact match, is to determine (730) whether there are one or more “close” matches. Close matches are matches that share a certain level of similarity. The threshold level for what constitutes “close” may be automatically set, may be user-selected, or may be some combination thereof. In embodiments, if one or more close matches with the command query exist, these close matches may be logged into an error log as potential errors in the documentation for that query command. As will be explained in more detail with respect to FIG. 8, in embodiments, these (potential) errors in the error log may be examined and some of them may be removed as not being errors.

If there are no close matches or if the close matches have been logged for that command, in embodiments, a check is performed (740) whether there are any remaining commands in the query set. If not all of the commands in the query set of commands have been queried against the command template database, then, in embodiments, the process returns to step 710 in which the next command from the query set of commands is selected.

As shown in FIG. 7, in embodiments, this cycle repeats until all commands in the query set of commands have been processed. In embodiments, once all of the commands in the query set of commands have been queried against the command template database, the corresponding error logs (or, in embodiments, a single error log) are output (745).

Given the error logs, in embodiments, these error logs may be further examined to reduce false positive error detections, to classify errors, or both. FIG. 8 presents an example methodology for performing error classification for one or more errors detected during command template querying according to embodiments of the present patent document. It shall be noted that the embodiment method of FIG. 8 may be performed going through the process for all error logs or may be perform for a single error log (and, in embodiments, may be repeated for another error log).

In embodiments, a reverse lookup of the close matches in the error log may be performed (805) against the set of flattened plain text commands to remove logged commands from the error log that are actually correct commands. Because a command may be similar to other valid commands, these commands may appear as close matches but are not actually errors. By checking whether these close matches in the error log match actual commands in the command definition data set, errors that are false positives can be readily removed.

In embodiments, a check is made whether there are any errors remaining in the log once the false positive errors have been removed. If there are no errors, an output of the results can be performed (820) showing that there are no errors.

If there are remaining errors in the error log, in embodiments, error classification may be performed on one or more of the remaining errors in the error log. In embodiments, the error classification may include checking one or more of the following: keywords, sequence of keywords, data types of value, range or values, and the like. For example, in embodiments, each command from the definition data set may be compared with a corresponding command template from the CT-DB. In embodiments, the comparison may be performed on the following categories:

(A) Keywords: check if key words between the query command and the corresponding command from the CT-DB are identical;

(B) Sequence of keywords: check if keywords in the query command and the corresponding command from the CT-DB appear in the same sequence;

(C) Data-Types of values: check if the data-types of the values for each key are same between the query command and the corresponding command from the CT-DB; and

(D) Range of values: check if the range of values between the query command and the corresponding command from the CT-DB are the same.

In embodiments, every comparison failure may be logged into the error log and the output of which may be provided (820) to a user for review and to take the appropriate action, such as correcting the documentation.

Consider, by way of illustration, the following example where the keywords [‘tagged’, ‘untagged’] are included in the documentation, but do not exist in the command definition data set in the code. A possible error in documentation where a feature not supported in the released product is present in its technical document.

Test Input: “interface vlan <>”, [“interface eth <>”,“interface vlan <>”]

CT-DB Output: “interface vlan <>”, [“interface eth <>”, “tagged interface vlan <>”, “untagged interface vlan <>”].

### 2. Querying the Command Context Database (CC-DB)

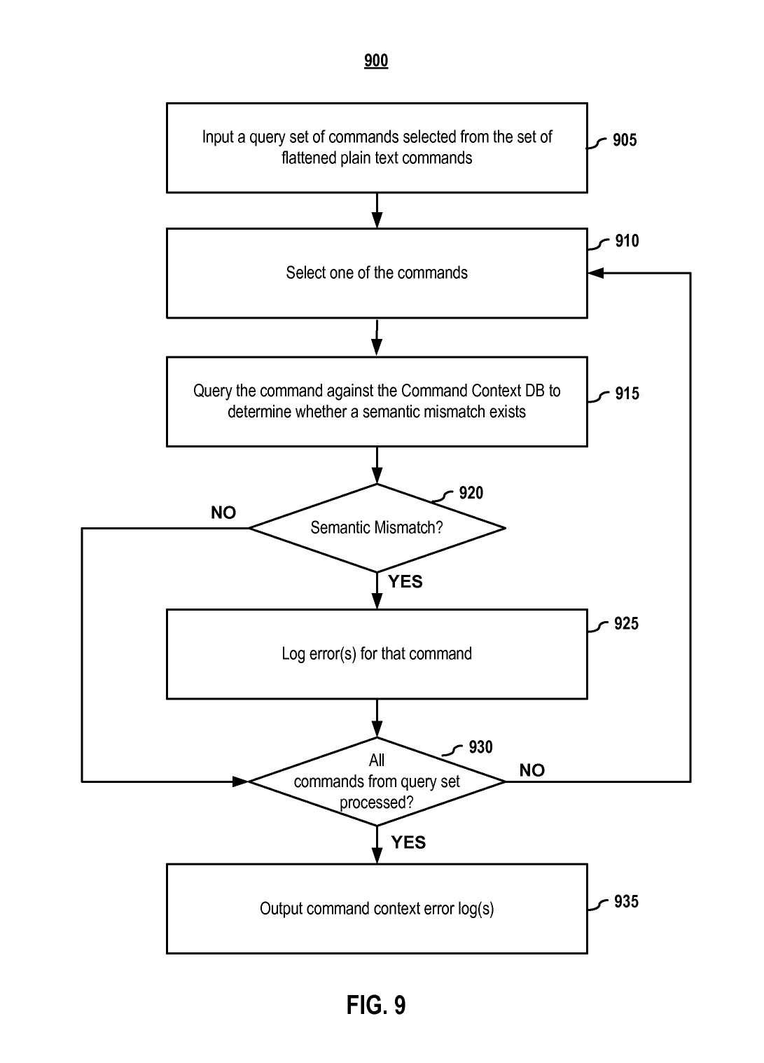

FIG. 9 depicts an example methodology for performing command context query according to embodiments of the present patent document. In embodiments, a query set of commands may be selected (905) from the set of flattened plain text commands. In embodiments, the query set may be all of the set of flattened plain text commands or may be a subset of them. Also, in embodiments, the selection may be by a user, may be selected automatically based upon one or more criteria, or may be a combination thereof. It shall also be noted that the query set of commands may be the same as those selected for verification against the command template database; and thus, in embodiments, this step may be skipped.

In embodiment, one of the command from the query set of commands is selected (910) to be tested against the command context database. This selected command is queried (915) against the command context database to determine whether there are any semantic mismatches with the query command relative to the data model of the command context.

For example, in embodiments, a semantic relevance test may be performed on each command line. In embodiments, a classifier iterates over each query command from the query set and queries the CC-DB for irrelevant words in the query command. In embodiments, the classifier may rely on the property of a vectorizer, such as Word2Vec, to generate vectors for words in the input corpus, which satisfy the property that the semantic similarity between words varies linearly with the cosine similarity between the vectors. Hence, the vectors of words which are semantically related are closer to each other than the vectors corresponding to unrelated words. In embodiments, the genism library function Word2VecModel.doesnt_match( ) function may be used to perform this semantic comparison and returns unrelated words. In embodiments, a command context classifier makes use of this function to find semantic outliers present in the query set of commands, but not covered in the technical document. The semantic mismatches may be logged into a “Context Error Log”.

Consider the following example: model.doesnt_match ([‘config-mode’, ‘interface’, ‘vlan’]). If it returns an empty set, then all words are semantically related; that is, from the documentation it can be inferred that ‘interface vlan’ is available in “config” mode. If the text of the documentation had erroneously represented ‘interface vlan’ to be an “exec” mode command, the test would return ‘config-mode’ as an outlier. In embodiments, this error may not be caught in the command template comparison since the mode of configuration is typically not part of the command and hence may not be present in the block of text representing the command in the technical document.

Returning to FIG. 9, the returned results may be examined (920) to ascertain if one or more semantic mismatches exist. In embodiments, if one or more mismatches are returned, then the mismatches may be logged (925) for this command.

Whether or not there are mismatches, in embodiments, a check is performed (930) whether there are any remaining commands in the query set. If not all of the commands in the query set of commands have been queried against the command context database, then, in embodiments, the process returns to step 910 in which the next command from the query set of commands is selected.

As shown in FIG. 9, in embodiments, this cycle repeats until all commands in the query set of commands have been processed. In embodiments, once all of the commands in the query set of commands have been queried against the command context database, the corresponding error logs are output (935).

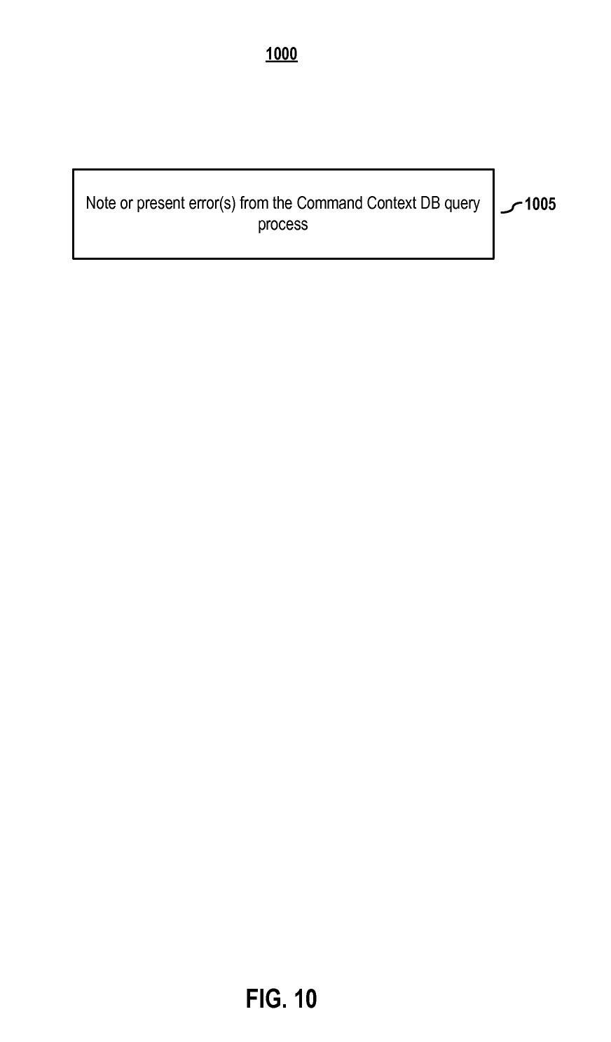

Given the error logs, in embodiments, these error logs may be further examined. FIG. 10 presents an example methodology for providing errors for one or more errors detected during command context querying according to embodiments of the present patent document. In embodiments, the detected mismatches from the command context database query process may be noted (1005), displayed to a user for further examination, or crosschecked against a list of common issues to reduce false positives and other issues.

### E. EXAMPLES

Presented here are some examples to help illustrate the usefulness of the document verification system. These examples are provided by way of illustration only and shall not be used to limit the scope of the present patent document.

### 1. CLI Documentation Data-Model Error Example

The CT-DB did not detect a key named “name” in the VLAN creation template. This leads us to infer documentation did not cover this newly introduced parameter.

| | | |
|---|---|---|
| Command | CT-DB | Command Definition |
| Section | (Extracted template for Topic | Data Set |
| | ″Vlan Creation″) | (″Vlan Creation″) |
| Dell S5000 | { | { |
| vlan | key: ″interface″, value:″vlan″ | key: ″interface″, value: |
| creation | key: ″vlan″ , value:<slot- | ″vlan″ |
| | vlan> | key: ″vlan″, value:<slot- |
| | } | vlan> |
| | | key:″name″, value:<vlan- |
| | | name> |
| | | } |

### 2. CLI Documentation Success Example

| | | |
|---|---|---|
| CLI- | CT-Corpus(p) | CLI definition file |
| Corpus(p) | ( Extracted template for Topic | (Element for ″Vlan |
| | ″Vlan Creation″) | Creation″) |
| Dell S5000 | { | { |
| vlan | key: ″interface″, value: ″vlan″ | key: ″interface″, |
| creation | key: ″vlan″, value:<slot-vlan> | value: ″vlan″ |
| | key: ″name″, value:<vlan- | key: ″vlan″, value: |
| | name> | <slot-vlan> |
| | } | key: ″name″, value: |
| | | <vlan-name> |
| | | } |

### 3. CLI Documentation Execution Order Error Example

The CT-corpus has detected an incorrect order of execution for the CLI. This leads us to infer documentation has covered the execution order incorrectly.

| | | |
|---|---|---|
| CLI- | CT-Corpus(p) | CLI definition file |
| Corpus(p) | ( Extracted template for Topic | (Element for ″Vlan Creation″) |
| | ″Vlan Creation″ ) | |
| Dell S5000 | { | { |
| vlan | key:″interface″, value:″vlan″ | key:″interface″, value:″vlan″ |
| creation | key:″name″, value:<vlan- | key:″vlan″, value:<slot-vlan> |
| | name> | key:″name″, value:<vlan- |
| | key:″vlan″ , value:<slot- | name> |
| | vlan> | } |
| | } | |

### 4. CLI Documentation Context Error Example

| | | | |
|---|---|---|---|
| CLI- | CT-DB | CLI | Model.doesnt_ |
| section | ( Extracted | Normalized | match( ) |
| | template for Topic | Text | |
| | ″Vlan Creation″ ) | | |
| Dell S5000 | { | config-mode | Model.doesnt_match( |
| vlan | key: ″interface″, | command | [′config-mode′ |
| creation | value:″vlan″ | description: | ′command |
| | key:″vlan″ , | create a | description′ |
| | value:<slot-vlan> | vlan interface | ′create′ ′vlan′ |
| | key:″name″, | vlan <int> | ′interface′ ′ vlan′ |
| | value:<vlan-name> | name <str> | ′name′]) |
| | } | | Returns [′config- |
| | | | mode′] |

### F. SYSTEM EMBODIMENTS

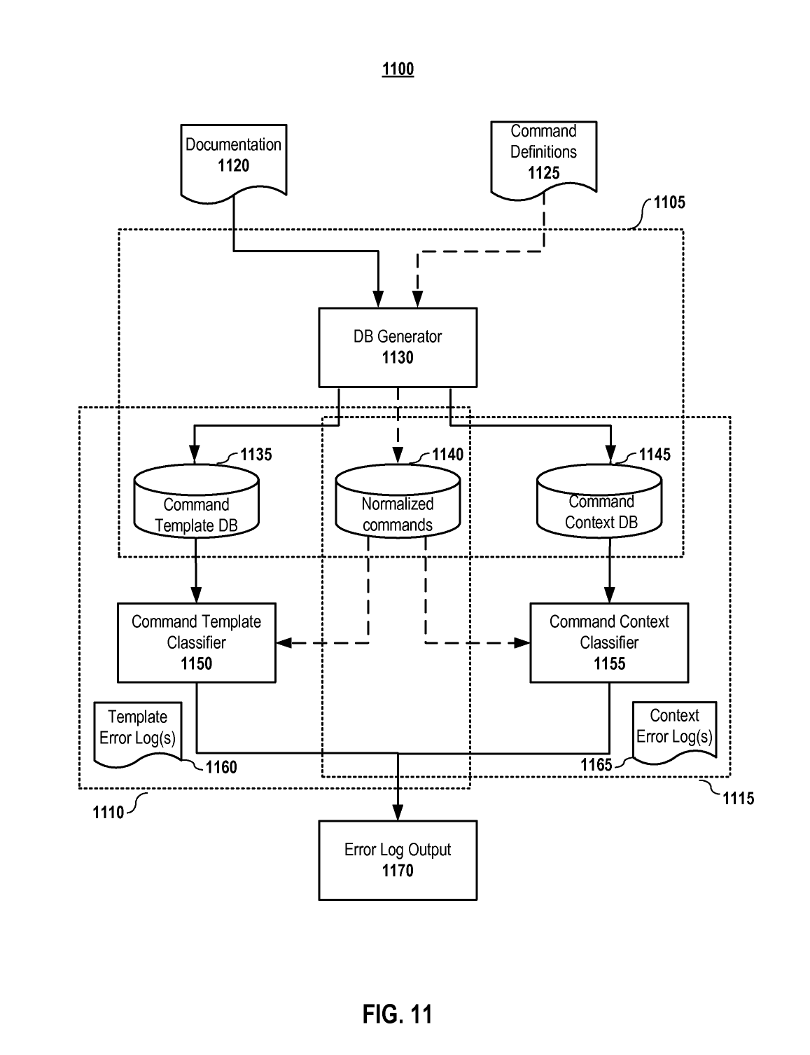

FIG. 11 presents an example document verification system according to embodiments of the present patent document. In the depicted embodiments, the system 1100 receives as inputs documentation 1120 for verification and a command definition data sent 1125 against which the documentation will be verified. In embodiments, the system 1100 outputs one or more error logs 1170 that indicate errors or potential errors in the documentation. In embodiments, the overall system may comprise three subsystems: a database generator system 1105 that generates database (which shall be understood to also mean or include data models and indices); a command template query system 1110, and a command context query system 1115.

It shall also be noted that, in certain embodiments depicted herein, that the query set of commands are selected from data obtained from the command definition data set and compared with the CT-DB, the CC-DB, or both. However, one skilled in the art shall recognize that the system may be configured to select one or more query command from the technical documentation system 1100 and compare them against commands from the command definition data set. In yet another alternative embodiment, the system may check commands in both ways as a cross-verification. It shall also be noted that as the system 1100 is used or as it is provided more documentation, it becomes more robust.

1. Database Generator System

In embodiments, the documentation 1120 is provided to database generator 1130, which takes the documentation and generates a command template database 1135. In embodiments, the database generator 1130 may obtain the command template database 1135 by performing the methods describe above with reference to FIG. 2 and FIG. 4.

In embodiments, the database generator 1130 also takes the documentation and generates a command context database 1145. In embodiments, the database generator 1130 may obtain the command context database 1145 by performing the methods describe above with reference to FIG. 2 and FIG. 5.

In embodiments, the database generator 1130 also takes the command definition data set 1125 and generates the normalized command set 1140, which may be the flattened plain text command set. In embodiments, the database generator 1130 may obtain the normalized commands 1140 by performing the methods describe above with reference to FIG. 3 and FIG. 6.

2. Command Template Query System

In embodiments, the command template query system 1110 comprises a command template classifier 1150 that access the command template database 1135 and the normalized commands 1140. In embodiments, the command template classifier 1150 receives a set of query commands and compares those against the command template database 1135 to obtain a command template error log or logs 1160. In embodiments, the command template classifier 1150 performs the methods describe above with reference to FIG. 7. In embodiments, the command template query system 1110 may also perform analysis of the command template error logs as described with reference to FIG. 8.

3. Command Context Query System

In embodiments, the command context query system 1115 comprises a command context classifier 1155 that access the command context database 1145 and the normalized commands 1140. In embodiments, the command context classifier 1155 receives a set of query commands and compares those against the command context database 1135 to obtain a command context error log or logs 1165. In embodiments, the command context classifier 1155 performs the methods describe above with reference to FIG. 9. In embodiments, the command context query system 1115 may also perform functions of presenting the errors and/or analyzing them as described above with reference to FIG. 10.

Finally, in embodiments, the template error log(s) 1160 and the context error logs 1165 may be combined by the system 1100 and output 1170.

Aspects of the present patent document are directed to information handling systems. For purposes of this disclosure, an information handling system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

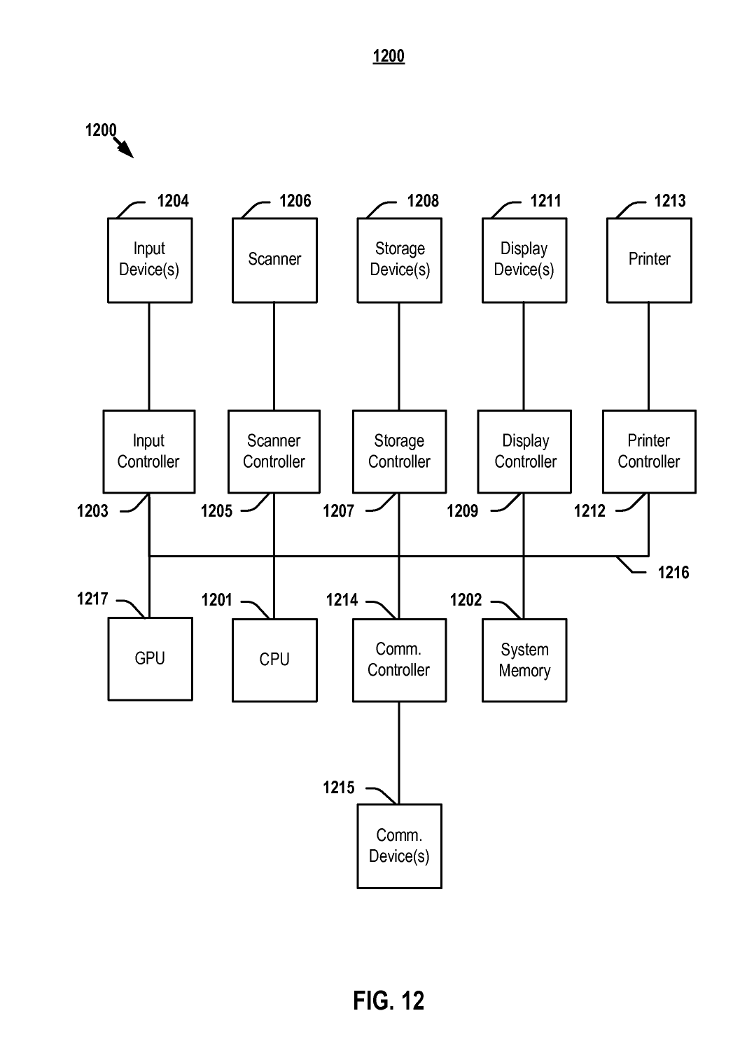

FIG. 12 depicts a block diagram of an information handling system 1200 according to embodiments of the present invention. It will be understood that the functionalities shown for system 1200 may operate to support various embodiments of an information handling system—although it shall be understood that an information handling system may be differently configured and include different components. As illustrated in FIG. 12, system 1200 includes a central processing unit (CPU) 1201 that provides computing resources and controls the computer. CPU 1201 may be implemented with a microprocessor or the like, and may also include a graphics processor and/or a floating point coprocessor for mathematical computations. System 1200 may also include a system memory 1202, which may be in the form of random-access emory (RAM) and read-only memory (ROM).

A number of controllers and peripheral devices may also be provided, as shown in FIG. 12. An input controller 1203 represents an interface to various input device(s) 1204, such as a keyboard, mouse, or stylus. There may also be a scanner controller 1205, which communicates with a scanner 1206. System 1200 may also include a storage controller 1207 for interfacing with one or more storage devices 1208 each of which includes a storage medium such as magnetic tape or disk, or an optical medium that might be used to record programs of instructions for operating systems, utilities and applications which may include embodiments of programs that implement various aspects of the present invention. Storage device(s) 1208 may also be used to store processed data or data to be processed in accordance with the invention. System 1200 may also include a display controller 1209 for providing an interface to a display device 1211, which may be a cathode ray tube (CRT), a thin film transistor (TFT) display, or other type of display. The computing system 1200 may also include a printer controller 1212 for communicating with a printer 1213. A communications controller 1214 may interface with one or more communication devices 1215, which enables system 1200 to connect to remote devices through any of a variety of networks including the Internet, an Ethernet cloud, an FCoE/DCB cloud, a local area network (LAN), a wide area network (WAN), a storage area network (SAN) or through any suitable electromagnetic carrier signals including infrared signals.

In the illustrated system, all major system components may connect to a bus 1216, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMS ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiment are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

What is claimed is:

1. A computer-implemented method for detecting errors in technical documentation related to a product comprising:
generating a command template database (CT-DB) comprising one or more commands extracted from technical documentation related to the product;
generating a command context database (CC-DB) comprising representations of contextual relationships of data extracted from technical documentation related to the product; and
using the command template database (CT-DB) and command context database (CC-DB) to verify information from technical documentation against a structured data set associated with the product.

2. The computer-implemented method of claim 1 wherein a command comprises one or more of a command line interface (CLI) command, an application program interface (API), operation, call, query, script, or input.

3. The computer-implemented method of claim 1 wherein the step of generating a command template database (CT-DB) comprising one or more commands extracted from technical documentation related to the product comprises:
extracting the one or more commands from the technical documentation related to the product;
creating a command corpus of structured commands in which each command is in a structured format; and
inputting the structured commands into an indexer for indexing.

4. The computer-implemented method of claim 1 wherein the step of generating a command context database (CC-DB) comprising representations of contextual relationships of data extracted from technical documentation related to the product comprises:
extracting text data from the technical documentation related to the product; and
vectorizing the text data to produce a trained model that comprises representations of contextual relationships between elements of at least some of the text data.

5. The computer-implemented method of claim 1 wherein the step of using the command template database (CT-DB) and command context database (CC-DB) to verify information from technical documentation against a structured data set associated with the product comprises:
querying a query command obtained from the structured data set against the command template DB to find a set of matches;
responsive to the set of matches not comprising at least one exact match, logging that this query command is missing from documentation;
responsive to the set of matches comprising one or more close matches, logging the one or more close matches as potential errors for that command; and
outputting the logged results.

6. The computer-implemented method of claim 5 further comprising the steps of:
for each close match that is logged:
performing a reverse lookup of the close match against a set of commands obtained from the structured data set; and
responsive to the close match having an exact match with a command in the set of commands obtained from the structured data set, removing the close match from the logged results.

7. The computer-implemented method of claim 6 further comprising the steps of:
after any potential errors have been removed from the logged results, performing error classification on one or more of the errors in the logged results to identify a type of error.

8. The computer-implemented method of claim 1 wherein the step of using the command template database (CT-DB) and command context database (CC-DB) to verify information from a document against a structured data set associated with the product comprises:
querying a query command obtained from the structured data set against the command context DB to determine whether a semantic mismatch exists; and
responsive to a semantic mismatch existing for the query command, logging the semantic mismatch for the query command.

9. The computer-implemented method of claim 1 wherein the structured data set associated with the product is obtain by performing the steps comprising:
converting a definition data set associated with the product into a set of flattened plain text commands; and
for each of the flattened plain text commands, replacing delimiters or tokens with whitespace to obtain a natural language-like representation of the flattened plain text command.

10. A documentation verification system for detecting errors in technical documentation related to a product, the system comprising:
a database generator that receives technical documentation related to the product and a definition data set related to the product and generates: (1) a command template database (CT-DB) comprising one or more commands extracted from technical documentation; (2) a command context database (CC-DB) comprising representations of contextual relationships of data extracted from the technical documentation; and (3) a set of normalized commands from the definition data set;
a command template classifier that uses at least part of the CT-DB to compare each query command from a set of query commands selected from the set of normalized commands to identify one or more errors in the set of query commands; and
a command context classifier that uses at least part of the CC-DB to perform a semantic relevance check on each query command from a set of query commands selected from the set of normalized commands to identify one or more errors in the set of query commands.

11. The documentation verification system of claim 10 wherein the database generator generates the command template database (CT-DB) by performing the steps comprises:
extracting the one or more commands from the technical documentation related to the product;
creating a command corpus of structured commands in which each command is in a structured format; and
inputting the structured commands into an indexer for indexing.

12. The documentation verification system of claim 10 wherein the database generator generates the command context database (CC-DB) by performing the steps comprises:
extracting text data from the technical documentation related to the product; and
vectorizing the text data to produce a trained model that comprises representations of contextual relationships between elements of at least some of the text data.

13. The documentation verification system of claim 10 wherein the command template classifier that uses at least part of the CT-DB to compare each query command from a set of query commands selected from the set of normalized commands to identify one or more errors in the set of query commands by performing the steps comprises:
querying a query command obtained from the structured data set against the command template DB to find a set of matches;
responsive to the set of matches not comprising at least one exact match, logging that this query command is missing from documentation;
responsive to the set of matches comprising one or more close matches, logging the one or more close matches as potential errors for that command; and
outputting the logged results.

14. The documentation verification system of claim 13 wherein the command template classifier further performs the steps comprising:
for each close match that is logged:
performing a reverse lookup of the close match against a set of commands obtained from the structured data set; and
responsive to the close match having an exact match with a command in the set of commands obtained from the structured data set, removing the close match from the logged results.

15. The documentation verification system of claim 14 wherein the command template classifier further performs the steps comprising:
after any potential errors have been removed from the logged results, performing error classification on one or more of the errors in the logged results to identify a type of error.

16. The computer-implemented method of claim 10 wherein the database generator generates the set of normalized commands from the definition data set by performing the steps comprising:
converting a definition data set associated with the product into a set of flattened plain text commands; and
for each of the flattened plain text commands, replacing delimiters or tokens with whitespace to obtain a natural language-like representation of the flattened plain text command.

17. A non-transitory computer-readable medium or media comprising one or more sequences of instructions which, when executed by at least one processor, causes steps to be performed for detecting errors in technical documentation related to a product, the steps comprising:
generating a command template database (CT-DB) comprising one or more commands extracted from technical documentation related to the product;
generating a command context database (CC-DB) comprising representations of contextual relationships of data extracted from technical documentation related to the product; and
using the command template database (CT-DB) and command context database (CC-DB) to verify information from technical documentation against a structured data set associated with the product.

18. The non-transitory computer-readable medium or media of claim 17 wherein the step of using the command template database (CT-DB) and command context database (CC-DB) to verify information from technical documentation against a structured data set associated with the product comprises:
querying a query command obtained from the structured data set against the command template DB to find a set of matches;
responsive to the set of matches not comprising at least one exact match, logging that this query command is missing from documentation;
responsive to the set of matches comprising one or more close matches, logging the one or more close matches as potential errors for that command; and
outputting the logged results.

19. The non-transitory computer-readable medium or media of claim 18 wherein the non-transitory computer-readable medium or media further comprises one or more sequences of instructions which, when executed by at least one processor, causes steps to be performed comprising:
for each close match that is logged:
performing a reverse lookup of the close match against a set of commands obtained from the structured data set; and
responsive to the close match having an exact match with a command in the set of commands obtained from the structured data set, removing the close match from the logged results.

20. The non-transitory computer-readable medium or media of claim 17 wherein the step of using the command template database (CT-DB) and command context database (CC-DB) to verify information from a document against a structured data set associated with the product comprises:
querying a query command obtained from the structured data set against the command context DB to determine whether a semantic mismatch exists; and
responsive to a semantic mismatch existing for the query command, logging the semantic mismatch for the query command.
